(19) United States
(12) Patent Application Publication
(10) Pub. No.: US 2005/0194398 A1
(43) Pub. Date: Sep. 8, 2005

(54) Container fitment comprising a dispensing orifice, and method of making the same

(75) Inventors: Mary Ruth Leyendecker, Cincinnati, OH (US); Marta Goyenechea-Mateos, Brussels (BE); Guy Hubert Stephane Sylvain Culeron, Rhode Saint Genese (BE); Kristi Marie Cetti, Mason, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/068,086

(22) Filed: Feb. 28, 2005

Related U.S. Application Data
(60) Provisional application No. 60/549,071, filed on Mar. 1, 2004.

(51) Int. Cl. B67B 7/00; G01F 11/00

(52) U.S. Cl. 222/1

(57) ABSTRACT

A container fitment comprising a dispensing orifice, articles of manufacture, and a method of making the same are disclosed. In one embodiment, the container fitment is used to dispense shear-thinning structured liquids and may include a dispensing ring in a shape other than a circle having a surface area opening from about 30 mm² to about 175 mm².

### CROSS REFERENCE TO RELATED APPLICATION

This application claims the benefit of U.S. Provisional Application No. 60/549,071, filed Mar. 1, 2004.

### FIELD OF THE INVENTION

The present invention relates to a container fitment, specifically a container fitment comprising a dispensing orifice, articles of manufacture, and a method of making the same.

### BACKGROUND OF THE INVENTION

Non-pressurized containers have been traditionally equipped with a dispensing orifice situated somewhere on the container. Traditionally, to dispense a product from a non-pressurized container, the user simply turns the container upside down and lets gravity do the work. However, in order to dispense an effective amount (such as, a unit dose) of a shear-thinning structured liquid product (such as, an automatic dishwashing and/or laundry composition), the user must provide at least some shear, which is generally initiated by squeezing the inverted container. The contents are then “squeezed” out of the container until the receiving receptacle is filled.

In dispensing shear-thinning structured liquid products or compositions, a balance must be achieved between providing an adequate dispensing orifice diameter (e.g. to result in an effective dosing of a receptacle with the shear-thinning structured liquid product) and providing a suitable flow rate once dispensing is initiated. Impacting the dosing regime is the negative perception of product quality that is elicited by the user when the dispensing orifice provides for either too restricted a flow (e.g. user perceives that the product is too thick) or too large a flow (e.g. user perceives that the product is too thin and watery). Therefore, to provide the highest consumer satisfaction during dosing, the dispensing flow rate of a shear-thinning structured liquid product may be controlled by the size, shape, and configuration of the dispensing orifice on the container fitment.

If the diameter of the dispensing orifice is too small, then only a limited amount of product is dispensed (often less than the optimal dosage) due to the large amount of shear produced as it is squeezed out the dispensing orifice. If less than the optimal dosage is delivered to a receiving receptacle (such as, the automatic dispensing cup in an automatic dishwashing machine or washing machine), then incomplete cleaning of a soiled article may occur.

As the diameter of the dispensing orifice increases, the dispensing flow rate increases. While this is desirable up to a certain point, too large a diameter and the user may actually lose control of the amount being dispensed—causing the user to overfill the receiving receptacle. Too large a diameter makes it difficult for the user to stop the dispensing flow with adequate control of the amount and direction of the flow. This often creates an unwanted mess (e.g. overfilling). Another problem with the use of large diameter dispensing orifices is that during dispensing, the user may perceive, the shear-thinning structured liquid product to be too thin and watery. Marketing tests have shown that a thin or watery product is perceived as being of lesser quality than that of a thicker product.

Thus, the size, shape, and configuration of the dispensing orifice are directly related to the user's perception of product quality. Therefore, the search for an improved container fitment has continued.

It has been surprisingly found that the design of a container fitment containing a dispensing orifice, and optionally a dispensing ring, having an opening with a surface area opening being greater than or equal to that of a circle with a diameter of 55.4 mm provides adequate control of the dispensing of a shear-thinning structured liquid without the negative appearance of the product being too thin or watery. It has also been surprisingly found that after the receiving receptacle is filled to the manufacturer's recommended dose volume, providing a “beveled edge” on the inner sidewalls of the optional dispensing ring reduces the messiness associated with cessation of the dispensing flow. The beveled edge helps the user “cut off” the dispensing flow rate of the product, especially at the end of the dosing operation, where most messiness is observed. Thus, when dispensing a shear-thinning liquid product, the container fitment provides a user with an overall improvement of the aesthetic experience in proper dosing.

Such a container fitment could also be used with most any type of composition, including non-shear thinning liquids or powders in any type of suitable containers (e.g. single- and multiple-compartment containers). Thus, any suitable composition may be dispensed from any suitable container using the container fitment, described herein. Suitable compositions include, but are not limited to: pastes, creams, gels, liquids, liquigels, powders, and granules. Although the examples herein typically relate to dispensing of structured automatic dishwasher and laundry products and compositions, this type of container fitment could be useful for a wide range of applications, including the dispensing of the following compositions: hand dish-washing products, skin care and personal care products, and food products.

### SUMMARY OF THE INVENTION

The present invention relates to a container fitment, specifically a container fitment comprising a dispensing orifice, an article of manufacture, and a method of making the same.

In one aspect of the invention a container fitment comprising an annular ring and a top panel is provided. The annular ring may comprise upper and lower terminal ends and an outer and inner sidewall. The inner sidewalls may comprise: (i) an attaching means for attaching the container fitment to the neck of a container opening; and (ii) a sealing means for sealing the container fitment to the neck of the container opening. The top panel may be positioned on the upper terminal end in a generally normal position to the terminal ends of the annular ring. The top panel may have a dispensing orifice located therein. The dispensing orifice may be non-circular in shape having a surface area opening from about 30 mm² to about 175 mm².

In another aspect of the invention, an article of manufacture is provided. The article of manufacture may comprise a kit comprising a container fitment, a container comprising a composition to be dispensed, and instructions for using the container fitment to dispense the composition. In another aspect of the invention, a method of manufacturing the container fitment, described herein, is provided. The method may comprise the step of forming a one-piece container fitment using plastic injection molding.

### BRIEF DESCRIPTION OF THE DRAWINGS

While the specification concludes with claims particularly pointing out and distinctly claiming the invention, it is believed that the present invention will be better understood from the following description taken in conjunction with the accompanying drawings in which:

FIG. 1 is a perspective view of one non-limiting embodiment of a container fitment having a dispensing orifice in the shape of a rhombus (e.g. four-sided diamond) thereon.

FIG. 2 is a top view of the container fitment shown in FIG. 1.

FIG. 3 is a cross-sectional view of the container fitment taken along line 3-4 of FIG. 2.

FIG. 4 is a cross-sectional view of the dispensing ring taken along line 4-4 of FIG. 2.

FIG. 5 is a perspective view of another non-limiting embodiment of a container fitment having a dispensing orifice in the shape of another rhombus (e.g. “Marquis” diamond) thereon.

FIG. 6 is a perspective view of another non-limiting embodiment of a container fitment having a dispensing orifice in the shape of an ellipse (e.g. football) thereon.

FIG. 7 is a perspective view of the container fitment of FIG. 1 and shows the mounting of the container fitment on a container.

### DETAILED DESCRIPTION OF THE INVENTION

The present invention relates to a container fitment comprising a dispensing orifice, an article of manufacturer, and a method of making the same. Generally, the container fitment may be independently attached to any suitable container by any suitable attaching means. Suitable attaching means include, but are not limited to: a snap lug arrangement, a screw threaded type arrangement, or combinations thereof. The container fitment may attach to right side up containers, as well as upside down containers, and is also useful for container openings with or without slit valves. The container fitment may also be provided as an integral part of a closure cap and/or sealing system for the container, especially one that provides for a fixed position or positive orientation closure cap, especially useful when the dispensing orifice in non-circular in shape. For example, the container fitment could be connected to the container via a flip cap or child resistant cap. Alternatively, the container fitment may be an integral part of the container itself.

The container fitment may also provide an access means whereby the container fitment may not be opened and exposure to the internal contents of the container achieved without exerting sufficient force to a portion of the container fitment. Thus, although the container fitment may not necessarily be child proof, the force required to remove it may provide some degree of resistance to child tampering and/or undesirable access to the contents of the container by children. The drawing and the shape of the container fitment and/or dispensing orifice and/or optional dispensing ring thereon may freely vary according to the required visual appearance of the finished shape of the container with which it is associated during the closing:of the container.

The container fitment may be made of any suitable material. Suitable materials include plastics. Suitable plastics include, but are not limited to: firm or rigid plastic materials, rubbery or flexible plastic materials, and combinations thereof. The container fitment may be provided as a one-piece article or a composite article. In one non-limiting embodiment, the container fitment may be made entirely of an elastically deformable or rubbery plastic material. In another non-limiting example, the majority of the container fitment itself may be made of an elastically deformable plastic material, but in this event it may be necessary to make certain that the portion where the attaching means is formed is not itself deformable. One solution is to utilize multiple-plastic injection molding systems, methods, and techniques, known in the art, to provide a single-piece container fitment having both flexible plastic components, and firm, deformable plastic components, alternatively rigid, non-deformable plastic components. Another solution to such an arrangement would be, for example, to prepare separately the attaching means (such as, a snap lug arrangement or a screw threaded type arrangement) itself and/or the dispensing ring of a more rigid or deformable, yet firm plastic material, alternatively a non-deformable plastic material, and to associate it with an elastically plastic deformable article to form the container fitment by well known processes. In this case the dispensing orifice may be melted, pressed, or cut out of the dispensing ring, if necessary.

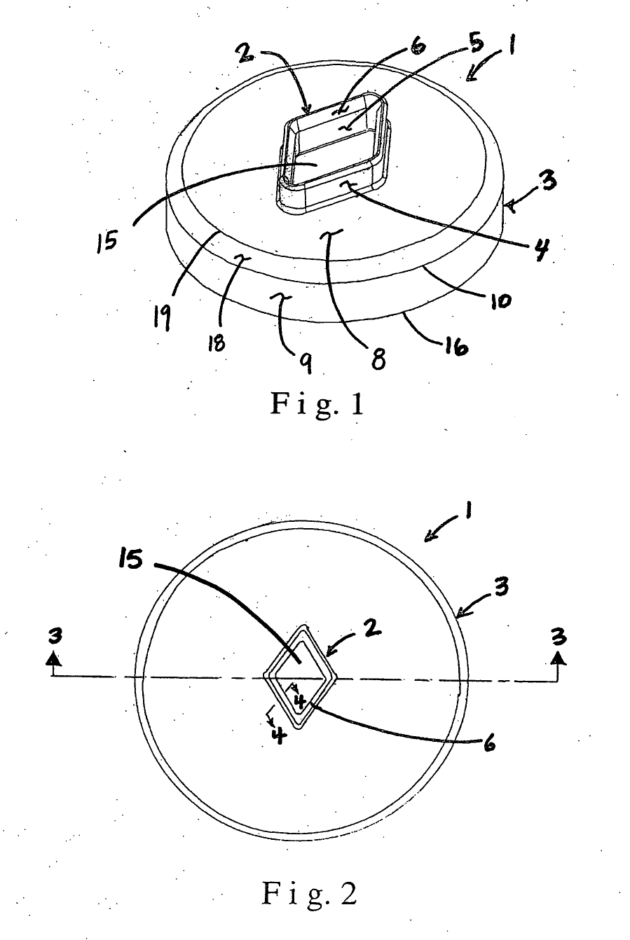

FIG. 1 shows a perspective view of one non-limiting embodiment of a container fitment 1 having a dispensing orifice 15 thereon. The container fitment 1 comprises an annular ring 3, a dispensing orifice 15, and an optional dispensing ring 2. The annular ring 3 having an upper and lower terminal ends 10 and 16, respectively, a top panel 8 being positioned on the upper terminal end 10 in a generally normal position to the terminal ends, the top panel 8 having a dispensing orifice 15 located therein.

The annular ring 3 further comprises an outer sidewall 9, and an inner sidewall (not shown). The lower terminal end 16 and an upper terminal end 10 define the outer sidewall 9. An optional transition element 18 may be connected to the top panel 8 and the annular ring 3 and is defined by the upper terminal end 10 of the outer wall 9 and outer terminal end 19 of the top panel 8. The optional transition element 18 may be; flat, curved, or rounded in shape.

The dispensing orifice 15 may be located ill any suitable location on the top panel 8. An optional dispensing ring 2 may also be provided. The dispensing orifice 15 and/or the optional dispensing ring 2, when present, may be located adjacent to one another. For example, the dispensing orifice 15 and/or the dispensing ring 2 may be centrally positioned on the top panel 8 such that an unobstructed passageway is created between the container opening (not shown) and the receiving receptacle to be filled.

The optional dispensing ring 2 may comprise an opening having the general shape of the dispensing orifice 15. The dispensing ring 2 comprises outer sidewalls 4, inner sidewalls 5, and optionally, beveled edges 6. The inner sidewalls 5 define a passageway or channel, which may be generally similar (or equal) in size, shape, or configuration to the size, shape, or configuration of the dispensing orifice 15. The passageway or channel (not shown) may be formed by the marriage of the dispensing ring 2 and the dispensing orifice which will provide direct communication with the contents of the container to the receiving receptacle during dispensing with little or no obstruction to the flow of the contents of the container from the container opening through the passageway or channel. The dispensing ring 2 may be act in combination with a closure cap (not shown) such as a flip-cap having a male member, wherein the dispensing ring 2 acts as the female member (not shown) to accept the male portion (not shown) of the closure cap (not shown) when tightly engaged (e.g. closed). The engagement thus provides a sealing means for sealing the contents of the container from the environment when in transport, storage, or not in use.

FIG. 2 is a top view of the container fitment shown in FIG. 1. The dispensing orifice 15 and/or dispensing ring 2 may be provided in any suitable size, shape, or configuration so as to aid in the control of the dispensing of the contents of a container. Non-limiting examples of a suitable geometrical shape include, but are not limited to: an annulus, an arbelos, an astroid, a paracycle, a cubocycloid, a circle, a circular sector, a circular segment, a cone, a crescent, a cube, a deltoid, an ellipse, a lune, an oval, a parallelogram, a penrose tile, a polydrafter, a polygon, a pyramid, a quadrilateral, a rectangle, a reuleaux polygon, a rhombus, a rotor, a ribbon, a salinon, a semicircle, a smoothed octagon, a square, a super ellipse, a trapezium, a trapezoid, a triangle, a triquetra, a yin-yang, and combinations thereof.

In some embodiments, the dispensing orifice 15 and/or dispensing ring 2 may comprise any shape that is non-circular, and has a point on it (i.e. two edges coming together to make a point). Suitable point-containing shapes include, but are not limited to: a 4-sided diamond (rhombus), a “Marquis” diamond (rhombus), a football (ellipse), triangle, rectangle, square, and combinations thereof. Point-containing shapes, especially like the 4-sided diamond shapes, allow the contents of the container, especially for liquids and gels, to be “cut off” at the end of the dosing, so that even when the contents appear to be coming out faster, the consumer does not experience increased messiness (e.g. dripping from the bottle) when the dosing is ceased. This added control provides a means to reduce the perception of a poor quality product (e.g. too “thin and watery”). The point-containing shape is also believed to act in concert with the beveled edge 6 to provide a “cutting edge” which helps promote the perception that the product is “pulled back” into the container at the end of the dosing. The cutting edge also appears to reduce the perception of messiness by the consumer at the cessation of dosing.

Any suitable surface area opening for the dispensing orifice 15 and/or dispensing ring 2 may be chosen to aid in the proper dosing of a receiving receptacle. Suitable surface areas openings include, but are not limited to surface areas openings from about 30 mm² to about 175 mm². In some non limiting embodiments, the surface area opening of the dispensing orifice 15 and/or dispensing ring 2 may be from about 30 mm² to about 175 mm², or from about 35 mm² to about 175 mm², or from about 40 mm² to about 175 mm², or from about 45 mm² to about 175 mm², or from about 50 mm² to about 175 mm², or from about 55 mm² to about 175 mm², or from about 60 mm² to about 175 mm², or from about 65 mm² to about 175 mm², or from about 70 mm² to about 175 mm², or from about 75 mm² to about 175 mm², or from about 80 mm² to about 175 mm², or from about 85 mm² to about 175 mm², or from about 90 mm² to about 175 mm², or from about 95 mm² to about 175 mm², or from about 100 mm² to about 175 mm², or from about 105 mm² to about 175 mm², or from about 110 mm² to about 175 mm², or from about 115 mm² to about 175 mm², or from about 120 mm² to about 175 mm², or from about 125 mm² to about 175 mm², or from about 130 mm² to about 175 mm², or from about 135 mm² to about 175 mm², or from about 140 mm² to about 175 mm², or from about 145 mm² to about 175 mm², or from about 150 mm² to about 175 mm², or from about 155 mm² to about 175 mm², or from about 160 mm² to about 175 mm², or from about 165 mm² to about 175 mm², or alternatively from about 170 mm² to about 175 mm².

Many shear-thinning structured liquids, however, are currently dosed from a container with a small, round, singular hole or orifice (e.g. often less than about 30 mm²) often providing the perception of too thick a product. In another non-limiting embodiment, a shear-thinning structured liquid may be dispensed from a container having a container fitment comprising a dispensing orifice 15 and/or dispensing ring 2 such that the surface area opening of the dispensing orifice 15 and/or dispensing ring 2 is greater than or equal to about 55.4 mm², which corresponds to the surface area opening of a circle having a diameter of 8.4 mm.

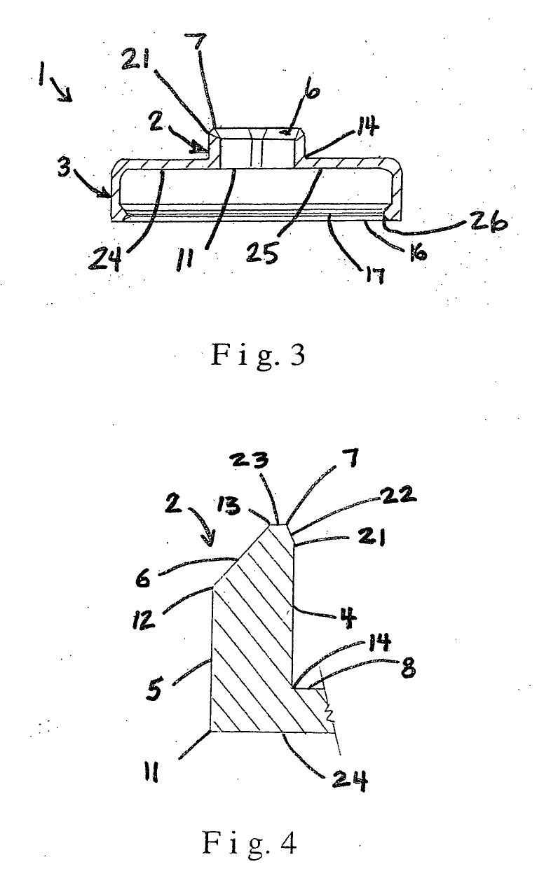

FIG. 3 is a cross-sectional view of the container fitment taken along line B-B of FIG. 2. In FIG. 3 the innermost structure of the container fitment 1 is shown. The annular ring 3 further comprises an inner sidewall 25, and an optional sealing surface 24, which may be an integral part of the innermost surface of the top panel 8. The inner sidewall 25 may comprise a suitable attaching means, such as snap lug arrangement or a screw threaded type arrangement for attaching the container fitment 15 to the neck of a container opening (not shown). In the embodiment shown, the inner sidewall 25 comprises a threaded member 17 located adjacent to the terminal end 16 of the container fitment 1. The inner sidewall 25 may be partially threaded having only a few threads, as shown, or may it may be fully threaded depending on the need (e.g. to resist the disengagement of the container fitment 1 from the container when a shear force is applied to the container by the user).

The optional sealing surface 24 may be located on the innermost surface of the top panel 8. The sealing surface 24, when present, may comprise a compressible, flexible and/or deformable material such that when the neck of the container opening is compressed against the deformable material it forms a tight seal when the container fitment 1 is fully attached to the neck of the container by any suitable attaching means (not shown), the seal being a leak proof seal.

In addition to (or alternatively, instead of) the optional sealing surface 24, the container fitment 1 may comprise an optional compressible, thickened portion 26 (or seal bead) located on the inner sidewall 25, adjacent to the lower terminal end 16. The thickened portion 24 may comprise a compressible, flexible and/or deformable material. The thickened portion 24 may be an integral part of the attaching means (e.g. part of the threaded member 17). When the container fitment is container fitment is fully attached to the neck of the container opening by a suitable attaching means, the thickened portion is compressed, forming a tight seal between the compressed thickened portion and the neck of the container opening, the seal being a leak proof seal.

FIG. 4 is a cross-sectional view of the dispensing ring 2 taken along line C-C of FIG. 2. The lower terminal end 14 and the upper terminal end 21 define the outer sidewall 4 of the dispensing ring 2. The inner sidewall 5 is defined by lower terminal end 11 to the upper terminal end 12. The outer terminal end 7 and the inner terminal end 13 define the top wall 23 of the dispensing ring 2. The upper terminal end 21 of the outer sidewall 4 and the outer terminal end 7 of the top wall 23 define the optional transition element 22. The inner terminal end 13 of the top wall 23 and upper terminal end 12 of the inner sidewall 5 defines the optional beveled edge 6. The optional beveled edge 6 may be flat or rectilinear.

The optional beveled edge 6 on the dispensing ring 2 may act as a “cutting edge” to allow the consumer to reduce the messiness associated with the cessation of the dispensing flow, especially for dispensing liquids and gels, as discussed above. The angle between the surfaces of the beveled edge 6, when present, and the outer sidewall 4 may comprise any suitable acute angle. Suitable acute angles include, but are not limited to: less than about 45 degrees, or less than or equal to about 44 degrees, or less than or equal to about 42 degrees, or less than or equal to about 40 degrees, or less than or equal to about 38 degrees, or less than or equal to about 36 degrees, or less than or equal to about 34 degrees, or less than or equal to about 32 degrees, or less than or equal to about 30 degrees, or less than or equal to about 28 degrees, or less than or equal to about 26 degrees, or less than or equal to about 24 degrees, or less than or equal to about 22 degrees, or less than or equal to about 20 degrees, or less than or equal to about 18 degrees, or less than or equal to about 16 degrees, or less than or equal to about 14 degrees, or less than or equal to about 12 degrees, or less than or equal to about 12 degrees. In one non-limiting embodiment, an acute angle is formed between the surfaces of the beveled edge 6 and the outer sidewall 4 and comprises from about 10 degrees to less than 45 degrees, of alternatively, from about 20 degrees to about 30 degrees.

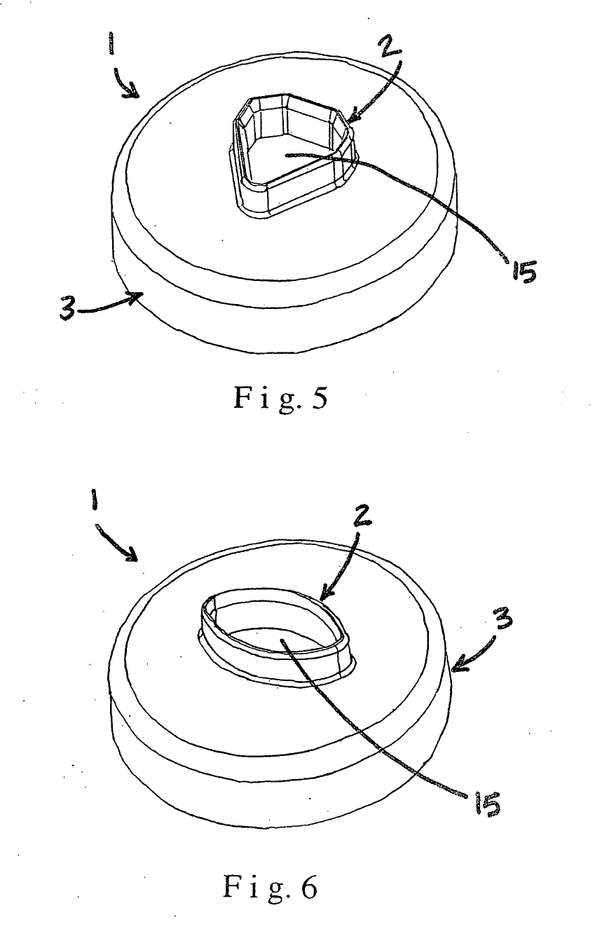

FIG. 5 is a perspective view of another non-limiting embodiment of a container fitment 1 having a dispensing orifice 15 and/or dispensing ring 2 in the shape of a “Marquis” diamond.

FIG. 6 is a perspective view of another non-limiting embodiment of a container fitment 1 having a dispensing orifice 15 and/or dispensing ring 2 in the shape of a football.

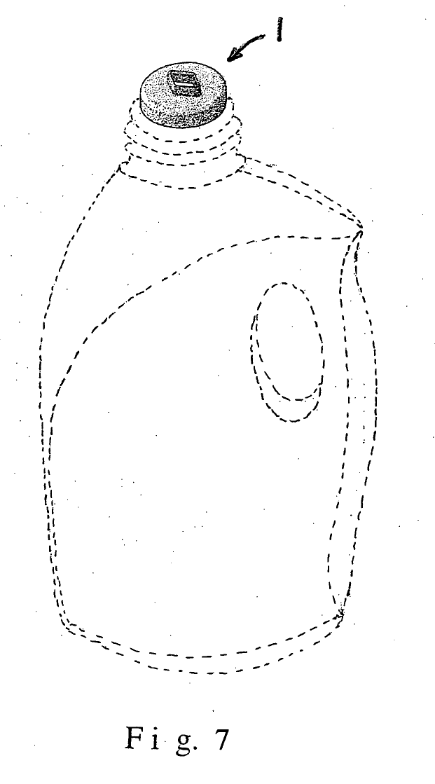

FIG. 7 is a perspective view of the container fitment of FIG. 1 and shows its mounting on a suitable container.

The container fitment may be packaged along with the container as an article of manufacture comprising a kit. The kit may include the container fitment, described herein, a container having a suitable composition stored therein, and instructions on the use of the container fitment during dispensing of the contents of any suitable container having any suitable composition in any suitable form. The container may have a single compartment or multiple compartments.

Alternatively, the instructions may provide for using the container fitment to dispense a shear-thinning structured liquid composition from any suitable container. Such instructions may include one or more of the following steps: (a) the user may hold the container between his thumb and fingers (not shown) in the upright position; (b) the user may turn the container upside down and exert an effective amount of force (e.g. by squeezing) to shear the shear-thinning structured liquid so that it dispenses from the container into a receiving receptacle (not shown); (c) as the shear-thinning structured liquid begins to flow through the dispensing orifice 15 and/or optional dispensing ring 2, the user may utilize one or more points of the point-containing dispensing orifice 15 and/or dispensing ring 2 shape (e.g. the four-sided diamond) to control the direction of the flow into the receiving receptacle; and (d) when the receiving receptacle begins to fill to the proper dosage volume, the user may move the container to the upright position, thereby engaging the cutting edge of the dispensing ring 2, if provided, so that the dispensing flow or stream of the product is cut off, which may help to reduce messiness (e.g. associated with unwanted drippings) once flow of shear-thinning structured liquid ceases.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification would include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation and the scope of the invention is defined by the appended claims which should be construed as broadly as the prior art will permit.

1. A container fitment comprising:
a) an annular ring having upper and lower terminal ends, and an outer and inner sidewall, said inner sidewall comprising:
(i) an attaching means for attaching said container fitment to the neck of a container opening; and
(ii) a sealing means for sealing said container fitment to the neck of said container opening; and
b) a top panel being positioned on said upper terminal end in a generally normal position to said terminal ends, said top panel having a dispensing orifice located therein, said dispensing orifice being non-circular in shape having a surface area from about 30 mm² to about 175 mm².

2. A container fitment according to claim 1, wherein said attaching means comprises one or more of the following: a snap lug arrangement and a screw threaded type arrangement.

3. A container fitment according to claim 2, wherein said attaching means is a snap lug arrangement.

4. A container fitment according to claim 2, wherein said attaching means is a screw threaded type arrangement.

5. A container fitment according to claim 1, wherein said sealing means comprises one or more of the following:
a) a compressible sealing surface located on the innermost surface of said top panel, said sealing surface comprising a flexible and/or deformable material such that the neck of said container opening is compressed against said deformable material forming a tight seal when said container fitment is attached to the neck of said container by said attaching means, said seal being leak proof; and
b) a compressible, thickened portion located on said inner sidewall adjacent to said lower terminal end, said thickened portion comprising a flexible and/or deformable material, said thickened portion is compressed when said container fitment is fully attached to the neck of said container opening by said attaching means, a tight seal is formed between said compressed thickened portion and the neck of the container opening, said seal being leak proof.

6. A container fitment according to claim 5, wherein said sealing means is a compressible sealing surface, said sealing surface being an integral part of the innermost surface of said top panel.

7. A container fitment according to claim 5, wherein said sealing means is a compressible, thickened portion located on said inner sidewall, said thickened portion being an integral part of said attachment means.

8. A container fitment according to claim 1, further comprising a dispensing ring located on said top panel adjacent to said discharge orifice, said dispensing ring having upper and lower terminal ends, a top wall, outer and inner sidewalls, and optionally a rectilinear beveled edge located on a portion of the inner sidewall on the upper portion of said dispensing ring, wherein said beveled edge forms an acute angle with said outer sidewall.

9. A container fitment according to claim 8, wherein said dispensing orifice and said dispensing ring are married, wherein said inner sidewall of said dispensing ring defines a passageway in direct communication with the contents of the container via the container opening.

10. A container fitment according to claim 9, wherein said dispensing ring comprises an opening being non-circular in shape having a surface area from about 30 mm² to about 175 mm² and said beveled edge.

11. A container fitment according to claim 10, wherein the angle between the surfaces of said beveled edge and said outer sidewall comprises an acute angle from about 10 degrees to less than 45 degrees.

12. A container fitment according to claim 11, wherein the angle between the surfaces of said beveled edge and said outer sidewall comprises an acute angle of from about 20 degrees to about 30 degrees.

13. A container fitment according to claim 10, wherein said dispensing orifice and/or said dispensing ring comprise a shape selected from the group consisting of an annulus, an arbelos, an astroid, a paracycle, a cubocycloid, a circle, a circular sector, a circular segment, a cone, a crescent, a cube, a deltoid, an ellipse, a lune, an oval, a parallelogram, a penrose tile, a polydrafter, a polygon, a pyramid, a quadrilateral, a rectangle, a reuleaux polygon, a rhombus, a rotor, a ribbon, a salinon, a semicircle, a smoothed octagon, a square, a super ellipse, a trapezium, a trapezoid, a triangle, a triquetra, a yin-yang, and combinations thereof.

14. A container fitment according to claim 13, wherein said dispensing orifice and/or said dispensing ring comprise a shape selected from the group consisting of a rhombus, an ellipse, a triangle, a square, a rectangle, a trapezoid, a ribbon, and combinations thereof.

15. A container fitment according to claim 14, wherein said dispensing orifice and/or said dispensing ring comprise a shape in the form of a rhombus or four-side diamond.

16. A container fitment according to claim 14, wherein said dispensing orifice and/or said dispensing ring comprise a shape in the form of a rhombus or Marquis diamond.

17. A container fitment according to claim 14, wherein said dispensing orifice and/or said dispensing ring comprise a shape in the form of an ellipse or football.

18. A container fitment according to claim 14, wherein said dispensing orifice and/or said dispensing ring comprise a shape in the form of a ribbon.

19. A container fitment according to claim 10 wherein the surface area of said dispensing orifice and/or said dispensing ring opening is from about 30 mm² to about 150 mm².

20. A container fitment according to claim 19 wherein the surface area of said dispensing orifice and/or said dispensing ring opening is from about 30 mm² to about 100 mm².

21. A container fitment according to claim 20 wherein the surface area of said dispensing orifice and/or said dispensing ring opening is from about 30 mm² to about 80 mm².

22. A container fitment according to claim 21 wherein the surface area of said dispensing orifice and/or said dispensing ring opening is from about 30 mm² to about 60 mm².

23. A container fitment according to claim 22 wherein the surface area of said dispensing orifice and/or said dispensing ring opening is greater than or equal to about 55.4 mm².

24. A method of manufacturing a container fitment, said method comprising the step of forming a one-piece container fitment using plastic injection molding, said container fitment comprising:
a) an annular ring having upper and lower terminal ends, and an outer and inner sidewall, said inner sidewall comprising:
(i) an attaching means for attaching said container fitment to the neck of a container opening; and
(ii) a sealing means for sealing said container fitment to said container opening;
b) a top panel being positioned on said upper terminal end in a generally normal position to said terminal ends, said top panel having a dispensing orifice located therein, said dispensing orifice being non-circular in shape having a surface area from about 30 mm² to about 175 mm²; and
c) optionally, a dispensing ring located on said top panel adjacent to said discharge orifice, said dispensing ring having upper and lower terminal ends, a top wall, outer and inner sidewalls, and optionally a rectilinear beveled edge located on a portion of the inner sidewall on the upper portion of said dispensing ring, wherein said beveled edge forms an acute angle with said outer sidewall.

25. A method according to claim 24, wherein said dispensing orifice and said dispensing ring are married, wherein said inner sidewall of said dispensing ring defines a passageway in direct communication with the contents of the container via the container opening.

26. A container fitment according to claim 25, wherein said dispensing ring comprises an opening being non-circular in shape having a surface area from about 30 mm² to about 175 mm² and a beveled edge

27. A container fitment according to claim 26, wherein the angle between the surfaces of said beveled edge and said outer sidewall comprises an acute angle from about 10 degrees to less than 45 degrees.

28. A container fitment according to claim 27 wherein the angle between the surfaces of said beveled edge and said outer sidewall comprises an acute angle of from about 20 degrees to about 30 degrees.

29. An article of manufacture comprising a one-piece container fitment comprising a kit, said kit comprising:
a) a container fitment comprising:
i) an annular ring having upper and lower terminal ends, and an outer and inner sidewall, said inner sidewall comprising:
(1) an attaching means for attaching said container fitment to the neck of a container opening; and
(2) a sealing means for sealing said container fitment to said container opening;
ii) a top panel being positioned on said upper terminal end in a generally normal position to said terminal ends, said top panel having a dispensing orifice located therein, said dispensing orifice being non-circular in shape having a surface area from about 30 mm² to about 175 mm² ; and
iii) optionally, a dispensing ring located on said top panel adjacent to said discharge orifice, said dispensing ring having upper and lower terminal ends, a top wall, outer and inner sidewalls, and optionally a rectilinear beveled edge located on a portion of the Inner sidewall on the upper portion of said dispensing ring, wherein said beveled edge forms an acute angle with said outer sidewall;
b) a container comprising a composition to be dispensed; and
c) instructions for using said container fitment when dispensing said composition from said container.

30. An article of manufacture according to claim 29, wherein said composition is the form of one or more of the following: paste, cream, gel, liquid, liquigel, powder, and granule.

31. An article of manufacture according to claim 30, wherein said composition is selected from the group consisting of dishwashing detergent compositions, laundry detergent compositions, hand dish-washing detergent compositions, skin care products, personal care products, and food products.
